(19) United States
(12) Patent Application Publication
(10) Pub. No.: US 2004/0103003 A1
(43) Pub. Date: May 27, 2004

(54) Method and system for insuring users of electronic trading systems or exchanges and traditional established commodity exchanges against weather-related risks and hazards

(75) Inventors: Mark M. Mayers, Pound Ridge, NY (US); David M. Fromer, New York, NY (US)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: E-COMM CONNECT, LLC, New York, NY

(21) Appl. No.: 10/303,127

(22) Filed: Nov. 22, 2002

(51) Int. Cl. G01W 1/00; G06F 19/00; G06F 169/00; G06F 17/60

(52) U.S. Cl. 705/4; 702/3

(57) ABSTRACT

Method and system for bundling a weather-related risk management product to the trading of commodities, such as agriculture, food, electricity, natural gas, oil and other products being traded through independent electronic commerce exchanges including business-to-consumer, business-to-business and traditional established commodity exchanges. A weather-related insurance product is created for a commodity which will specify the weather-related risk premium and compensation to be paid if certain defined events occur. The exchange offers the insurance product to its members, and for those that purchase the insurance product, a premium is added to the cost for each transaction in which the member is a party. By bundling a weather-related insurance product together with each trade or transaction, the weather-related risk premium is incorporated as an added transaction cost at the time the trade is confirmed. The amount of premium paid by each trading party may be accumulated and recorded as “weather credits”. Pursuant to the terms and conditions of the insurance product which vary depending upon the commodity and the risks being covered, different amounts of weather credits are required in order to obtain compensation for a weather-related incident. As such, insurance for weather-related risk is made easily and readily available to all buyers and sellers regardless of the platform used for trading.

### FIELD OF THE INVENTION

The present invention relates generally to a method and system for managing and insuring risks in business and consumer transactions and more specifically to methods and systems for managing and insuring weather-related risks in business and consumer transactions conducted via electronic trading systems or exchanges, or via conventional methods of trading as employed by established commodity exchanges.

### BACKGROUND OF THE INVENTION

The use of communication networks, such as the Internet, is expanding and as a result, independent electronic exchanges have been formed as competition to the existing traditional commodity exchanges to buy and sell “niche” market commodities, agriculture and other products. These exchanges collectively offer a wide variety of products, e.g., natural gas, electricity, oil, lumber, pulp and paper, spare parts, chemicals, agricultural and food products and more.

Some exchanges, used primarily by industry participants, are generally referred to as business-to-business exchanges (hereinafter “B2B exchanges”). These exchanges provide their users (members), through an electronic format, instant access to current information such as product availability, price, and other relevant conditions including weather conditions and forecasts. A major attraction for using a niche market electronic exchange is the system's capacity to offer a liquid and competitive pricing environment for the product(s) being offered. Theoretically, electronic exchanges reduce the inefficiencies found in traditional markets.

While electronic commerce systems may be changing the way both consumer and commercial business is being conducted, there are operating problems. Some of the problems relate to associated contract risks which may not be that much different from conventional trading or purchasing.

In addition to contract risks inherent in trading on all forms of exchanges, buyers and sellers trading certain products or commodities face weather-related risks. Weather-related risks are those “happenings” which occur as a result of changes in the weather such as significant temperature variances, either high and/or low; the absence of or a significant increase in rainfall, floods, tornadoes, hurricanes, and other weather happenings. While property and casualty insurance is generally available for most weather related risks, coverage is individually underwritten on a “case by case” basis. Weather-related risk protection is currently not available to buyers and sellers without the involvement of an individual insurance underwriting process.

Furthermore, business to consumer, independent B2B exchanges and the established traditional commodity exchanges do not offer weather-related risk protection for commodities being traded on their respective platforms. If a buyer or seller wants weather-related risk protection, the buyer or seller must contract directly with a surety company who is willing to consider and insure the risk

### OBJECTS AND SUMMARY OF THE INVENTION

It is an object of the present invention to provide a new method and system for providing weather related risk protection to business-to-consumer, B2B and traditional established exchanges trading weather-risk sensitive commodities and products.

It is another object of the present invention to provide a new method and system for managing and insuring risks in exchange-based transactions and more specifically a new method for managing and insuring weather-related risks in transactions conducted via an electronic communication network.

It is still another object of the present invention to permit an exchange to purchase or arrange weather-related risk protection from an independent and financially secure insurance company in a form that will permit the exchange to offer its members or customer's automatic insurance protection against defined hazards caused by weather.

It is yet another object of the present invention to provide a new method and system for providing weather-related risk protection to purchasers of a commodity in which claims related to weather risks would be paid based on the amount of the commodity purchased, and in which the premium paid on each trade transaction is accumulated to be used in the event of a loss.

It is another object of the present invention to provide a new method and system for providing weather-related risk protection to commodity traders in which an insurance product is included in agreements reached by the commodity traders to trade the commodity. An insurance product may be an insurance policy, financial or other forms of guarantee, and is hereinafter referred to as an insurance policy.

In order to achieve at least one of these objects to provide the insurance in a form readily available to a plurality buyers and sellers of a commodity and others, a method in accordance with the invention comprises creating a weather-related insurance policy for a specific commodity or commodities being traded which will specify at a minimum the weather-related risk premium and compensation to be paid if certain defined events occur. Once a policy is issued with the defined coverage and other terms and conditions, the policy is written and delivered to the operator of the exchange(s). The exchange in turn offers the protection to its members, and for those that accept to purchase the insurance coverage, a premium is added to the cost for each transaction in which the member(s) is a party. For example, most exchanges operate by providing a means for the members to post offers to buy and sell the commodity being traded on that specific exchange and a means to receive acceptances indicating an agreement to buy and/or sell the commodity as a specifically defined trade transaction. When acceptances are received, the transaction is confirmed by notice to both parties and the insurance coverage is automatically included in the trade transaction.

In this manner, by associating or bundling a weather-related insurance policy together with each trade or transaction, the weather-related risk premium (“premium”) is incorporated as an added transaction cost at the time the trade is confirmed. As such, insurance for weather-related risk is made easily and readily available to all buyers and sellers regardless of the platform used for trading.

In one embodiment, each party can commit themselves to accepting the weather-related insurance policy for all transactions conducted within a specified period of time, e.g., one year. In other words, in conjunction with the first transaction by each party, each party may bind themselves through an agreement with the exchange to purchase the weather-related insurance policy for that transaction and all subsequent transactions within a specified period of time at the same terms and conditions. Such an agreement could also be required of each party as a condition for membership in the exchange.

Commodities which may be traded on an electronic commerce trading exchange or system and for which weather-related risk protection may be provided in accordance with the invention include, but are not limited to, natural gas, electricity, oil, lumber, pulp and paper, spare parts, chemicals and agricultural and food products.

Unlike most conventional insurance policies where an annual premium is charged, in one embodiment of the invention, the buyer and seller of a commodity desirous of purchasing weather-related protection are charged a premium on each transaction in which either party is involved throughout the year, thereby accumulating “weather credits” which impact the amount paid by an insurance company in the event of a covered incident, such as a pre-defined weather situation and/or a loss. In this embodiment, the policy would include a condition governing the allotment of such weather credits to the counter-parties upon payment of the premium, with each weather credit corresponding to an amount of paid premium.

As the buyers and sellers engage in multiple transactions, the weather credits are accumulated in respective, separate accounts. Another condition of the insurance policy establishes the amount of a claim to be paid for a weather-related incident based on the accumulation of a predetermined, threshold number of weather credits. When a claim is paid for a covered incident defined in the policy (not necessarily a loss), the number of weather credits in the account is reduced by the amount of compensation paid for that specific claim. The policy can contain other limiting conditions imposed by the insurance company.

To create a weather-related risk policy for a specific commodity, the risks are identified and analyzed, limits for the insurance coverage are established, including, for example, the amount of the claim(s) to be paid in the event of the occurrence of an insured risk, as well as the premium. Methods for collecting the premiums must be determined and agreed upon for accepting the defined risks.

The weather-related risk for the commodity will be analyzed by an independent insurance company having risk management expertise. The insurance company will determine the premium based on the use of historical data and other underwriting criteria required to accurately evaluate the risk and assess the premium. The premium may be determined based on trading a standard-unit on the exchange for the specific commodity. In this manner, protection is readily available for every transaction on the exchange without the need to analyze each transaction on a case-by-case basis in order to determine a premium. This approach differs from the conventional approach where individual underwriting strategies are employed.

Preferably, both the buyers and sellers will be charged the premium on each transaction in which they are involved. After a premium is paid, in the event of a weather-related incident, each party would be compensated based on the amount of premium paid and other policy considerations.

For example, in one embodiment, in order to be paid a claim under the weather-related risk policy, a premium must have been paid. The amount of a claim that a party may be paid for a weather-related incident is related to the amount of the premium paid so that generally, in order to receive, for example, a million dollars, more premium must be paid than to receive, for example, a hundred thousand dollars. The threshold levels to realize a monetary benefit from the insurance company may vary depending on the commodity and specific policy conditions.

In one embodiment of the invention, the existence of a direct loss resulting from the weather conditions is not required as a condition for receiving compensation pursuant to the weather-related risk policy. As such, as long as the weather conditions fall within coverage conditions as set forth in the policy and sufficient premium has been paid, a claim will be paid.

In another embodiment however, the buyer and/or seller must have sustained a direct loss resulting from a weather incident and this is a condition for receiving compensation pursuant to the weather-related risk policy. In such an embodiment, if no direct loss is incurred, no compensation would be paid even if a defined hazard (weather condition) within the terms of the policy occurs. Buyers and sellers may be given an option when purchasing the insurance as to whether a loss should be a condition for obtaining compensation. The premium and/or underwriting conditions may be varied depending on whether such a loss is a condition for obtaining compensation.

In another embodiment, the potential buyers and sellers of the commodity are connected to a server over a communication network. Offers to buy and sell are posted on a server and transmitted over the communication network. Acceptances are likewise received at the server and transmitted over the communication network. When two parties accept an offer, a confirmation stating the trading conditions is transmitted via the communication network to the counter-parties. This notification includes the amount of premium due for the transaction. In this manner, the weather-related risk premium is presented to the parties over the communication network in conjunction with the trade. As such, the insurance is easily and readily made available to the parties to the transaction.

Another way of considering the invention is to provide insurance coverage to an electronic commerce exchange (a B2B exchange) in which transactions are conducted between buyers and sellers of a commodity using a server and remote terminals connected over a communication network to the server. The weather-related risk for the commodity and the specific transaction is analyzed. A premium for the commodity is determined by an insurance company. The buyer and seller are notified of the premium via a server and remote terminals over the communication network and upon acceptance of coverage by either or both counter-parties, payment of the premium is included in the confirmation and subsequent billing, thereby providing weather-related risk protection insurance for the specific trade transaction, thereby enabling the buyers and sellers of the commodity to easily obtain such protection.

In one embodiment, a claim for a weather-related incident, possibly but not necessarily involving a loss in value of the commodity, is paid only after a predetermined threshold amount of premium has been paid. Specifically, the amount of premium paid by the buyers and sellers for insured transactions over a period of time may be added or accumulated, e.g., in respective, separate accounts maintained on the server, and when the amount of premium paid is greater than a threshold amount of premium, the account holder becomes entitled to compensation. Otherwise, the account holder is not compensated for weather-related incidents until the amount of premiums paid reaches the threshold.

In another embodiment, instead of adding the premium to the cost of the transaction, it is possible to provide a system for using weather credits where the premium is embedded in the price of the commodity. With each purchase, weather credits would be allotted to the parties to the transaction corresponding to a set amount of weather-related risk premium. In this case, weather credits would accumulate in respective, separate accounts for each party and thereafter, compensation may be paid for a weather-related incident after a threshold number of weather credits have been accumulated. To implement the methods described above, a system for trading a commodity through an electronic commerce exchange includes a server on an electronic commerce exchange. The server comprises a processor and a memory component including a trading program, electronic links for coupling the server to remote terminals accessible by buyers and sellers of the commodity over a communication network, and access to a risk assessment program for assessing a weather-related risk of trades on the electronic commerce exchange and creating an insurance policy for the trades based on the risk. The risk assessment program is coupled to the processor to enable the processor to notify the trade participants of the terms and conditions of the insurance policy including the premium, the compensation payable and the events covered by the policy. The risk assessment program may be resident on the memory component or on a server of an insurance company coupled to the trade-insuring server over the communication network.

The trade participants would be notified of the insurance premium when the trade is confirmed and the premium would be included as a transaction cost. In this case, the insurance coverage is integrated into the trade agreement. The processor may be designed to determine the amount of premium paid in conjunction with multiple trades. Upon occurrence of a covered weather-related incident, a program on the server can be used to determine and authorize the payment of a claim to the party or parties experiencing the weather-related incident. In said application, the program would determine if a payment can be paid based on policy considerations and premium paid. The weather-related incident for which compensation may be sought does not have to involve a loss in value of the commodity as compensation might be obtainable without a loss, depending on the type of insurance coverage purchased.

In the alternative, the processor may allot weather credits to the buyers and sellers as a function of the premium paid in conjunction with trades by the buyers and sellers, accumulate the weather credits in respective, separate accounts for the buyers and sellers, and upon occurrence of a covered weather-related incident, authorize compensation to a party for the weather-related incident when the accumulated total of weather credits is equal to or greater than a predetermined threshold amount.

The invention is also applicable for use in connection with sales of commodities, such as seeds for grass or other plant life, wherein the weather risk insurance is bundled with the sale of the goods, and the compensation is determined as a function of weather credits, as discussed hereinabove. Such sales may be from a retail or wholesale supplier of the commodities.

### BRIEF DESCRIPTION OF THE DRAWINGS

The invention, together with further objects and advantages hereof, may best be understood by reference to the following description taken in conjunction with the accompanying drawings, wherein like reference numerals identify like elements, and wherein:

FIG. 1 is a flow chart showing the operation of an exchange which offers insurance to members in accordance with the present invention.

FIG. 2 is a flow chart showing a manner in which weather credits are used in accordance with the invention.

FIG. 3 is a block diagram showing the major components of a system in accordance with the invention.

FIG. 4 shows a map of the United States and Canada depicting, for illustration purposes, temperature regions used to determine weather-related risks used in the invention.

FIG. 5 is a table showing one method in which weather credits are used in accordance with the invention.

FIG. 6 is a flow chart showing the operation of an exchange providing for optional insurance coverage in accordance with the invention.

FIG. 7 is a flow chart showing the use of weather credits in an exchange providing for optional insurance coverage in accordance with the invention.

### DETAILED DESCRIPTION OF THE PREFERRED EMBODIMENTS

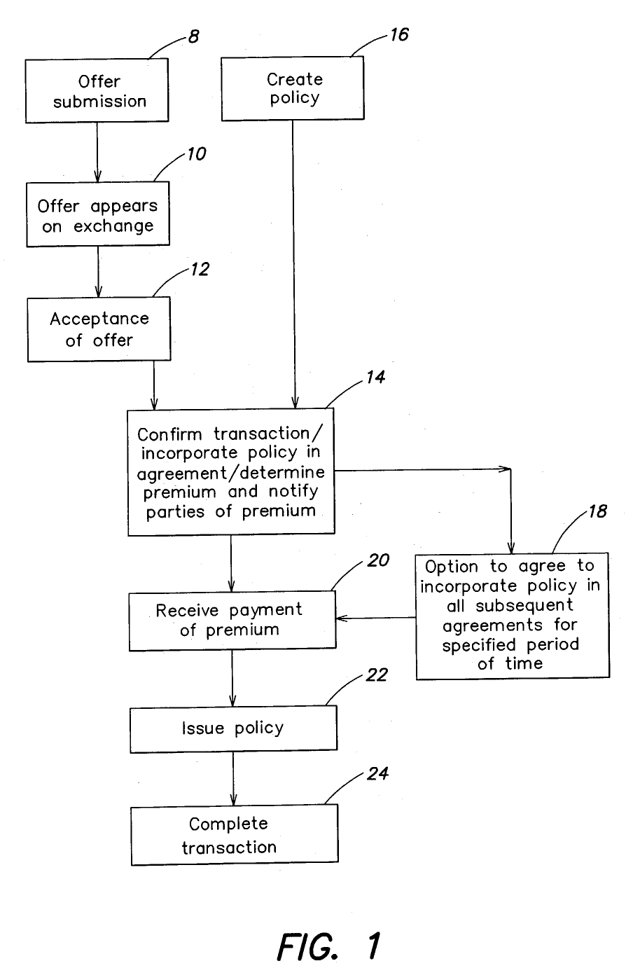

FIG. 1 shows the manner in which a transaction is conducted on an exchange involving the use of weather-related risk protection in accordance with the invention. In the exchange, buyers and sellers of a specific commodity are joined by membership and prequalified by a membership application process. During the membership process, members have the right to accept or decline weather-related risk protection being offered by the Exchange. If the member accepts, a premium is assessed on each transaction in which the member is involved. The member accumulates “weather credits” on which claims are paid in the event of a happening which triggers a payment as defined in the policy. The members submit offers to buy or sell defined units of the commodity (at 8) and such offers are transmitted to the members of the exchange (at 10). When a n offer is accepted (at 12), the counter-party has either bought or sold the defined unit of the commodity subject to the agreed price, trade terms and exchange trading policies. The transaction is confirmed (at 14) and both parties to the trade are expected to abide by exchange rules for completing the trade (at 24).

In one scenario, a potential buyer submits an offer to buy one or more standard units of a commodity on the exchange and the offer is transmitted to the terminals of the buying and selling members. A potential buyer submits an offer (at 8) to buy a portion of or all of the standard units of the commodity to the seller. If both parties are in agreement, the transaction is confirmed (at 14) with the exchange notifying both parties that the seller has accepted the buyer's offer. The exchange may list the particulars for the transaction such as the price, date and quantity of the standards units. Other transaction-related activities would also be conducted such as the forwarding of the required payment from the buyer and seller to the exchange or to an independent clearing service. Once the transaction is confirmed, the buyer and seller would be expected to abide by the rules of the exchange for completing the transaction.

Typically, the exchange comprises an electronic system organized to create a market in a designated commodity or commodities. Offers to buy or sell, as well as acceptances, are processed by software that resides on a central controlling computer, for instance a network server.

In conjunction with the confirmation process at 14, weather-related insurance coverage is tied to the transaction for the member(s) who previously elected to purchase said coverage and agreed to pay the premium. The policy is prepared, delivered, and accepted by all parties (policy created at 16). The policy incorporates all the relevant terms and conditions such as the specific coverage for weather-related incidents, the amount of premium, how the premium is paid, and the manner and amount of a claim(s) to be paid for a weather-related incidents. The amount of premium to be paid may be based on a standard unit of the commodity by either quantity or the total value of the contract. (When weather credits are used as discussed below, then the policy would also set forth the number of weather credits required to effect a claim.)

To create the policy (i.e., at 16 in FIG. 1), the risk for a specific commodity is identified and defined by the insurance company. The premium or charge required to cover the defined risks is determined. The policy contains conditions relating to the occurrence of a weather-related incident which will entitle the policyholder to indemnification (payment) from the insurance company, subject to the underwriting terms and conditions set forth in the policy.

Once the policy terms are defined and the premium is determined, the terms and premium are incorporated as a part of offers on the exchange for those parties participating in the coverage. The risk, and thus the premium and/or weather-related incidents entitling compensation (payment), may vary for different transactions depending for example on the geographical area in which the commodity is to be delivered.

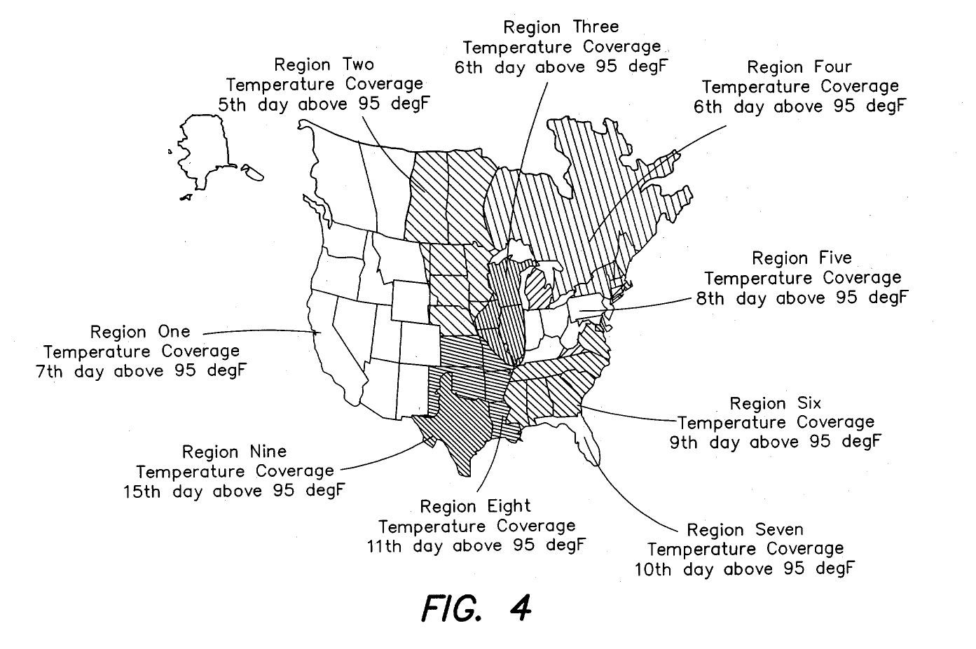

More particularly, there are certain identifiable weather-related risks associated with various commodities. These risks can vary for each commodity being traded and also usually vary depending upon the geographical area in which the risk exists and the type of weather. For example, FIG. 4 shows a map of the United States and Canada divided into weather regions based on temperature. Each weather region has a specific claim criteria relating to the first day in the month of July that the temperature is above 95° F. for which insurance coverage for weather-related incidents would be available. As an example, in Region One, the western U.S., insurance coverage would be available for the seventh day, and subsequent days, in the month of July when the temperature is above 95° F.

The amount of the required premium may vary with the amount of commodity involved in each transaction, the value of the transaction and/or the geographic location for the delivery of the commodity. Other factors can be used to provide for variations in the premium. Although the premium for each transaction may be the same for equivalent amounts of the commodity or for equal value transactions, the events which would trigger payment of a claim may vary from one transaction to another and would be dependent, for example, on the delivery of the commodity involved in the transaction.

The policy, including the premium required, the compensation payable and the conditions triggering payment, is disclosed to the buyer and seller in the confirmation of the transaction at 14 with the premium being a part of the transaction cost. Although in this embodiment, the premium is an integral part of the transaction, the premium may also be displayed to the buyer and seller separately prior to the transaction being confirmed, thereby affording each party an opportunity to decline the insurance, if allowed by the exchange. The party that does not purchase weather-related risk protection does not obtain the benefits of the weather-related insurance policy.

In conjunction with the confirmation of the transaction, an option can be provided to each party to the transaction to enable the automatic purchase of weather-related risk protection for all subsequent transactions entered into by that party within a specified period of time at the same terms and conditions (at 18) (assuming that party has not already agreed to automatically purchase weather-related risk protection for the transaction in question).

The premium required pursuant to the policy is received (at 20) and then a weather-related insurance coverage is in force (at 22).

Under the terms of the policy, the policyholder is entitled to compensation for covered weather-related incidents as specified in the policy. There may be a master policy which sets forth that all transaction for which premiums are paid provide the weather-related risk protection, subject to the terms and conditions of the policy.

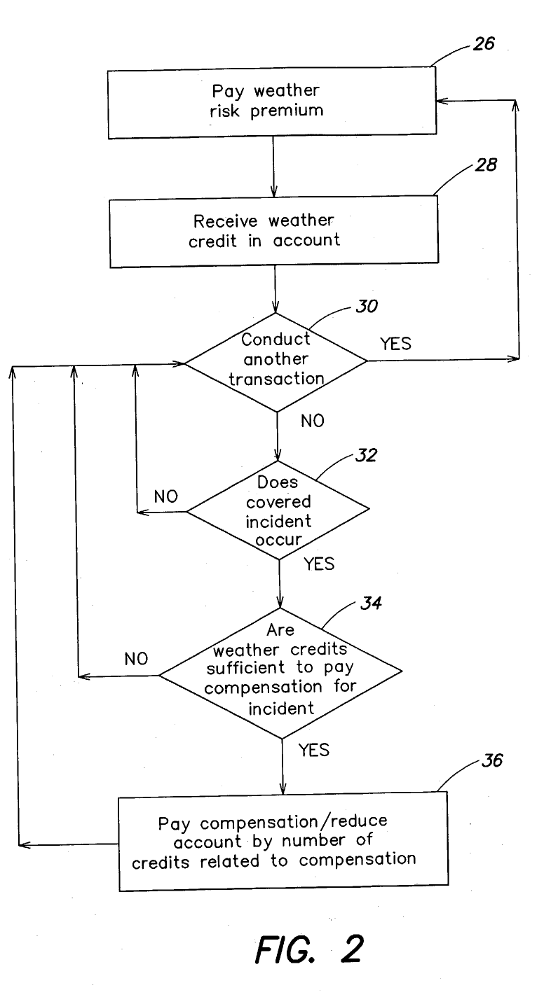

Referring now to FIG. 2, the manner in which compensation is paid for a defined incident pursuant to the insurance policy is explained. As noted above, an incident for which compensation may be paid does not have to involve a direct loss by the insured. Compensation can be paid when an insured incident occurs without a direct loss. When the premium is paid (at 26), “weather credits” are credited for the purchaser in an account at the exchange (at 28). Each purchaser (party) has a separate account.

The weather credits establish the amount of the claim to be paid in the event of certain defined events. The weather credits are based on the amount of premium paid for the insurance coverage pursuant to the policy. Generally, as more premium is paid as a result of multiple transactions or large transactions, claim payments will be higher. The payment for a claim, irrespective of a direct loss, for example, may be in the range of 5-15 times the amount paid in premiums, less an underwriting expense. The actual multiple is to be determined by an underwriting analysis.

For subsequent transactions, a determination is made at 30 as to whether the account holder has agreed to purchase the coverage. If so, when the premium for this subsequent transaction is paid, additional weather credits are earned and are added to the amount in the party's account which is maintained by the exchange.

The events which trigger the payment of a claim may vary based on underwriting criteria and may vary for different members.

For subsequent transactions of a party, a determination is made at 30 as to whether the account holder is conducting a subsequent transaction since the invention may be used for a series of transactions conducted over a span of time. In this manner, the process is a continual, ongoing process, e.g., over the course of a year or more, with the weather credits accumulating for each transaction until a covered incident occurs. Indeed, it is envisioned that multiple transactions will be conducted by the member buyers and sellers of the exchange before a covered incident occurs since a single transaction may not involve payment of sufficient premium (i.e., to reach a threshold amount) to entitle a buyer or seller to compensation for a covered incident. If another or subsequent transaction is conducted, when the premium for this transaction is paid, additional weather credits are earned and added to the amount in the account.

If a covered incident occurs, a determination is made at 34 as to whether the account holder and claimant has sufficient weather credits in the account to be entitled to payment for the incident, i.e., is the number of weather credits in the account equal to or above a threshold amount to entitle compensation. In other words, has the claimant paid sufficient premium to be entitled to receive a money payment for the incident? If not, then the incident will not be covered. No future claim will be paid until the claimant has conducted more transactions and paid additional premiums to reach the required threshold payment.

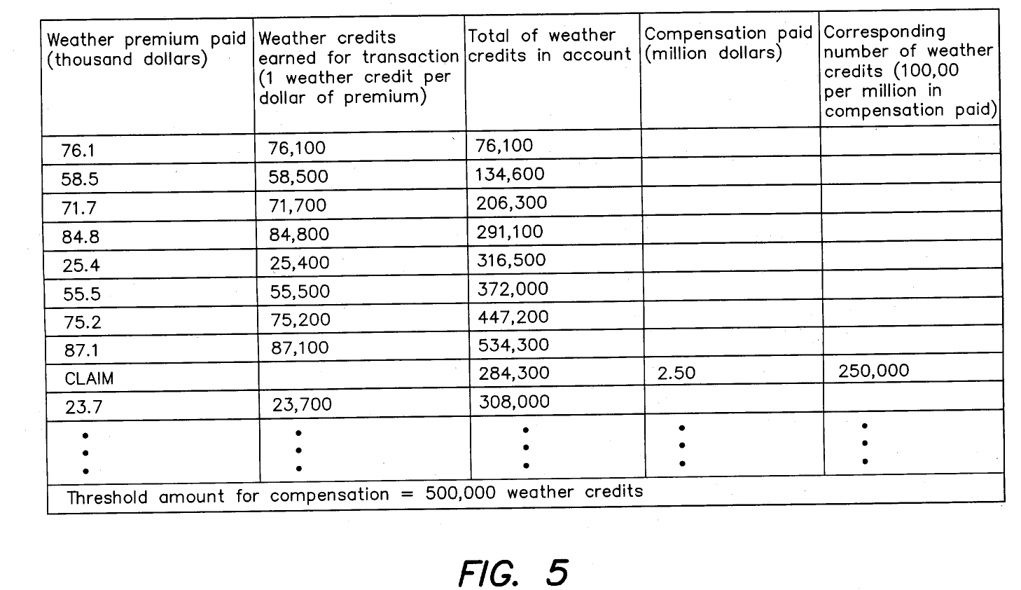

If the claimant has sufficient weather credits in their account to be entitled to payment for an incident, then the claimant is compensated, and the weather credit account is reduced to reflect the number of credits corresponding to the amount paid (at 36) (see also the discussion of FIG. 5 below). It is envisioned that the claimant will then conduct additional transactions, accumulate additional weather credits and apply them to future weather-related incidents.

The number of weather credits used (corresponding to the compensation paid) may differ from the threshold amount of weather credits required to effect compensation. That is, a party may be required to have a certain number of weather credits to be entitled to receive any compensation. The reduction in the number of weather credits for a payment may be less than the total number of credits to the account since payment is not based on the total number of weather credits in an account, but payment is based on policy terms.

Referring now to FIG. 5, a table is shown in which the premiums paid for several transaction are listed. In this non-limiting example, a weather credit is earned for each dollar of premium paid and is accumulated in a separate account. If a claim is submitted after the number of accumulated weather credits is over 500,000, the threshold to entitle compensation, the compensation paid for the claim is $2.5 million dollars. The relationship between the compensation and the number of weather credits is 100,000 weather credits per million dollars of compensation. Thus, a compensation payment of 2.5 million dollars will cause a reduction of 250,000 weather credits in the account as shown in FIG. 5.

As another example of the application of the method in accordance with the invention, the method will be described for an exchange dealing in electricity. Weather has a profound impact on various aspects of electricity. For example, in the mid-eastern region of the United States, as temperatures increase, the demand for electricity increases. If and when the temperature exceeds the norm for a sustained period of time, servicing the demand becomes more difficult and costly since higher temperatures increase the cost of producing and delivering electricity.

An analysis of weather statistics in the mid-eastern region of the United States for the past twenty-five years will be used by an underwriter to develop underwriting conditions and premium pricing.

In this example, it is assumed that members of the exchange are buying and selling (trading) electricity during all twelve months of the year. Electricity is sold in the form of Megawatt Hours (MwHrs). Further, it is assumed that the trading activity by members will vary. Some will trade limited amounts of electricity and others will trade substantial amounts of electricity.

In accordance with one embodiment of the present invention, a set premium is imposed for each MwHr of electricity bought and sold. The premium is based on an underwriting procedure which examines weather patterns of prior years and other factors. The buyer and/or seller who elects to purchase weather-related risk insurance protection are charged the same premium per MwHr and are given the same number of weather credits. However, the event(s) that trigger the payment of a claim may vary based on the underwriting criteria. For the seller, the governing factor may be the location of the generator. For the buyer, the governing factor may be the delivery point.

Weather credits are earned for each transaction upon payment of the premium. The credits accumulate as more trades are made and are maintained in a separate “weather credit account” for each party. The credits are used in the event of occurrence of certain predetermined happenings or events. For example, assume that in a given region, it has been predetermined that an incident will occur in a month where the temperature exceeds 95° F. for six days (whether consecutive or not). Accordingly, on the sixth day and everyday thereafter in the same month where the temperature exceeds 95° F., a predetermined number or quantity of weather credits are-used by the holder to effect a claim. In one scenario, as an example, each weather credit is equivalent to $1.00 of premium and the holder of 100,000 credits is to be paid $800,000 in the event of the defined incident (i.e., the ratio of the premium paid to the claim in this illustration is 1:8).

The payment for each day or the total payment for weather-related incidents may be limited and will be governed pursuant to the terms, conditions and limitations set forth in the policy.

If a member does not have 100,000 credits in his weather credit account, he will not be paid any compensation until he has accumulated 100,000 credits or such other minimums as may be imposed. Thus, by paying the premium, weather credits are accumulated and stored for later use as a basis for compensation for a weather-related incident. The more weather credits accumulated by a buyer or seller increases the potential amount of compensation in the event of a weather-related incident.

The number of credits that may be used in a single day, or in any other time period, may be limited. If a member has used all of his credits in that day and there is a subsequent incident-day as defined in the policy, no payment is made nor accrued. The member will only be entitled to realize a financial recovery at such time as a sufficient number of credits for premium payment have been accumulated at the time the incident occurred.

The premiums collected from trading activities will be paid to the insurance company underwriting the risks. After a deduction for marketing and underwriting expenses, the remaining funds, at the discretion of the insurance company, may be deposited into an interest bearing reserve account. Interest earned and the absence of the payment of claims over a length of time may increase the amount paid when claims occur and are paid.

Instead of using temperature as the basis for paying a claim, the number of inches of rainfall can be used as the basis for triggering a claim. Both a decline or substantial increase in rainfall could result in losses by the buyer or seller of the commodity and thus require payment of a claim. For example, assume that the average rainfall in an area or region is 25 inches per year. Through an underwriting approach, it is determined that if the rainfall is less than 20 inches or more than 30 inches in a year, weather credits could be used to realize claim benefits. The same scenario as above enumerated for temperature could be used in this application for rainfall.

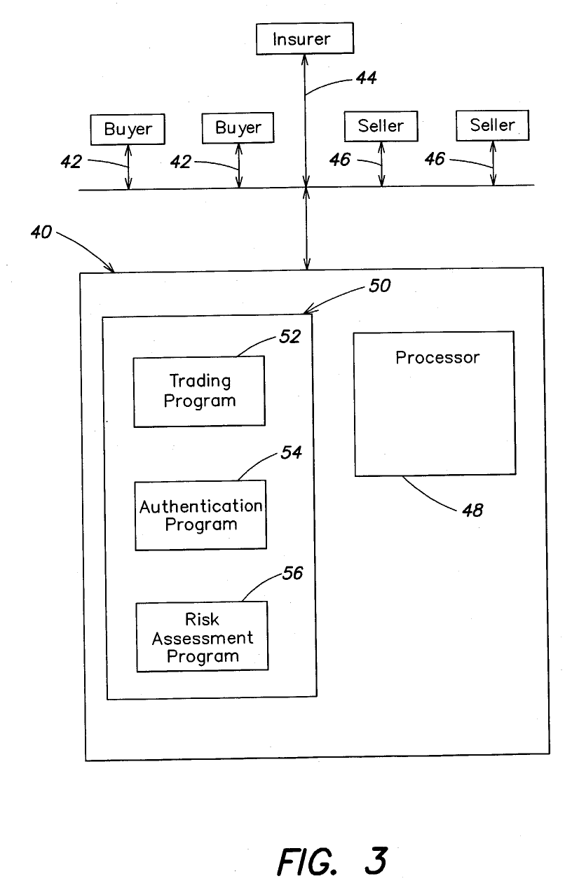

FIG. 3 illustrates a system 40 for insuring trades on an electronic commerce exchange using a communication network. In this case, the exchange, embodied in software resident on a server, is linked via links 42 to buyers, via a link 44 to an insurer and via links 46 to sellers. System 40 has a processor 48 and a memory component 50. Memory component 50 has a trading program 52 and optionally, an authentication program 54. When the system 40 receives a signal from a remote terminal via one of the links 42,46, such as an offer to sell units of a commodity from a buyer via a link 42, processor 48 runs the authentication program 54 to ensure that the signal comports with, for example, the requirements of a membership agreement. If the signal from the remote terminal is authenticated, the signal is passed to a trading program 52. Trading program 52 sends signals indicating the offer to sell to the remote terminals via links 42,46. Another member of the exchange, such as a seller at a remote terminal, can accept the offer by sending a signal conveying the acceptance back to the system 40 via one of the links 46. When an acceptance signal is received from a remote terminal, trading program 52 causes system 40 to send a signal to the counter-parties notifying them that a trade has been made. Trading program 52 also preferably sends a signal to the other linked remote terminals setting forth the terms of the trade without identifying the parties.

When the signals notifying the counter-parties are sent notifying them of the trade, the data relating to the agreement, e.g., the commodity, the date(s) of transfer, etc., are sent to a risk assessment program 56 which analyzes the risk. As shown, the risk assessment program 56 is contained in the memory component 50. However, the risk assessment program 56 can be situated at the insurer. In this case, the data relating to the agreement is transmitted via link 44 to the insurer and the premium is quoted by the insurer to the system 40 via the link 44. If the insurance is accepted, the processor 42 receives the premium and notifies the parties of the commodity via the appropriate links.

As another alternative, the insurance component is automatically included in the transaction costs, and the parties do not have the option of accepting or not accepting the insurance component.

If the insurer is connected to the communication network, then it can accept payment of the premium from the buyer and/or seller (and/or the exchange operator) electronically. In the alternative, the processor 42 can be provided with a payment acceptance program for accepting payment of the premium and forward payment to the insurer. In the alternative, the parties can pay the exchange or its designee who in turn will credit the payee's account and pay the insurance company. It is important to receive payment of the premium. Otherwise, the transaction would not be covered by insurance. Generally, insurance policies are not valid unless payment is received, so receipt of payment is essential for the generation of weather-related risk insurance.

The foregoing method enables buyers and sellers of a commodity using an electronic exchange such as a B2B exchange to readily and easily obtain weather-related risk insurance to entitle them to compensation for weather-related incidents irrespective of whether a loss (i.e., a loss in value of the commodity) is involved.

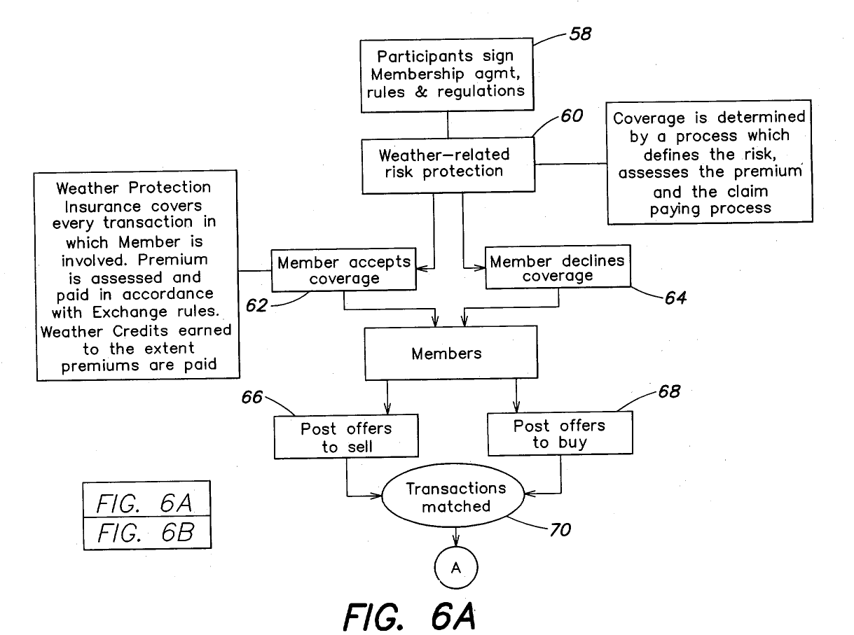

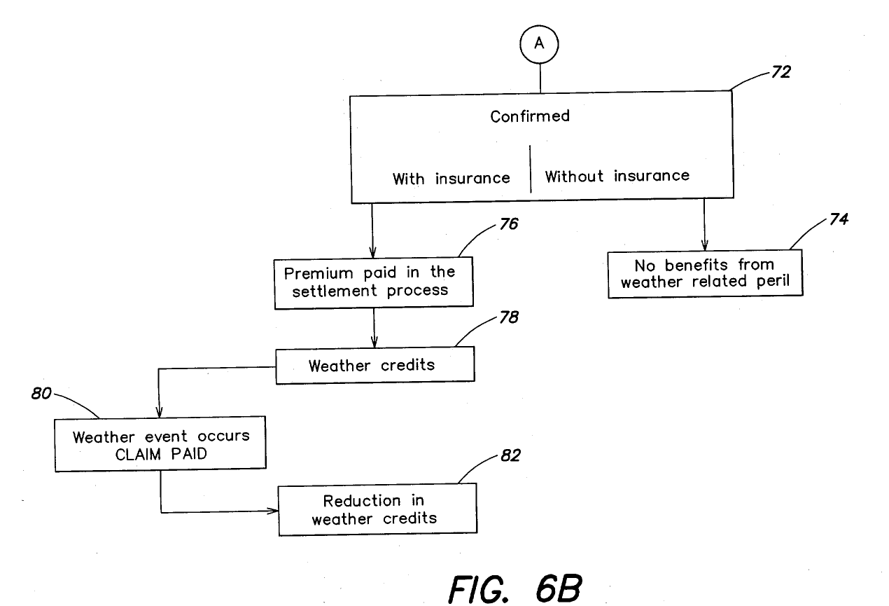

Referring now to FIG. 6, in this embodiment, the purchase of weather-related risk insurance is optional. Thus, the participants in the exchange each sign a membership agreement containing rules and regulations (at 58) and are notified of the existence of weather-related risk protection at 60. At this time, each member can either accept coverage (at 62) or decline coverage (at 64). In conjunction with the acceptance of coverage by means of an agreement with the exchange, the agreement can include a provision to bind the member to purchase weather-related risk insurance for all transactions conducted within a specified period of time. In the alternative, the member can purchase weather-related risk insurance for an initial transaction and at the same time, agree to purchase weather-related risk insurance of all subsequent transactions within a specified period of time.

Thus, any agreements entered into by those members who have agreed to purchase the insurance policy, within the specified period of time, will have the insurance policy automatically incorporated into the agreement. On the other hand, those members who have elected not to automatically purchase the insurance product will not have the insurance policy automatically included into any agreements they enter into. However, they can still be provided with the option to purchase the insurance policy in conjunction with each transaction.

The members post offers to buy and sell the commodity on the exchange at 66,68 and transactions are matched at 70. At 72, the transactions are confirmed with the parties to each transaction either purchasing the insurance policy or not, i.e., including the insurance policy in the agreement to the benefit of one or both parties or not. If the insurance policy is not purchased by a party, then benefits will not be received for weather-related incidents (at 74).

If the insurance policy is purchased by a party to the agreement, then a premium will be paid by that party in the settlement process (at 76) and weather credits will be earned corresponding to the premium paid (at 78) and added in an account assigned to that party. When a weather event occurs, the party seeking compensation pursuant to the insurance policy will be paid, provided a threshold number of weather credits are in that party's account (at 80). Thereafter, the account will be reduced by a number of weather credits corresponding to the claim paid (at 82).

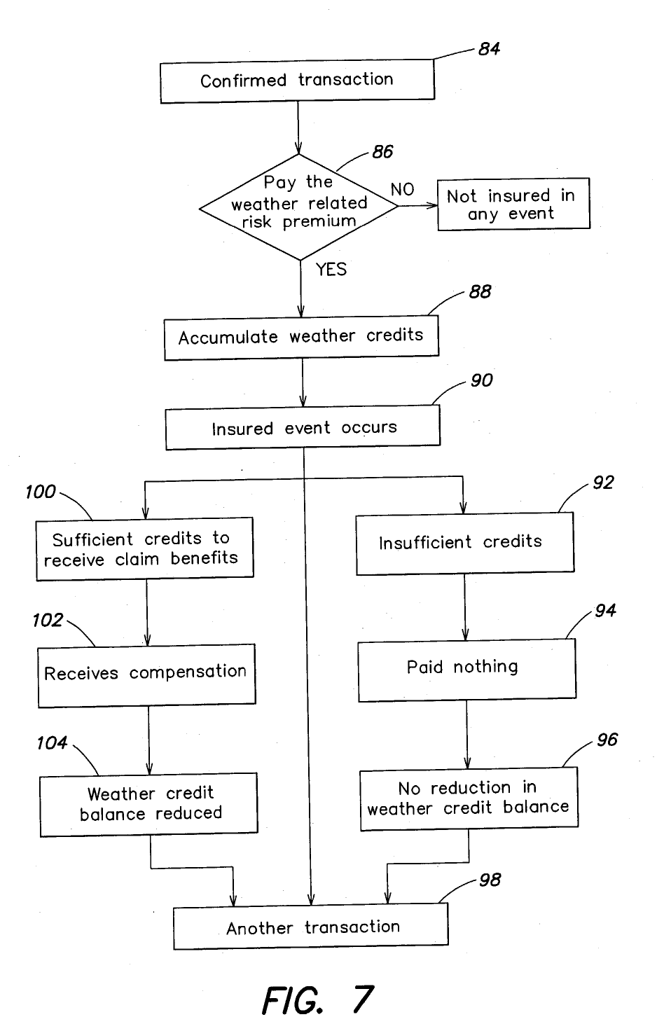

With respect to the allotment of weather credits, reference is made to FIG. 7 which shows the procedure subsequent to the confirmation of a transaction (at 84). When the premium for the insurance policy is paid (at 86), weather credits corresponding to the amount of premium paid are allotted and accumulate in the payor's account (at 88). If the premium is not paid, then the insurance policy is not issued and no insurance for weather-related risks is obtained.

If an insured event occurs as defined in the insurance policy (at 90), it must be considered whether the party seeking compensation pursuant to the policy has sufficient weather credits to receive benefits pursuant to the policy. If the number of weather credits is insufficient to obtain compensation (at 92), then the claimant is not paid (at 94) and there is no corresponding reduction in the amount of weather credits in that party's account (at 96). That party may conduct additional transactions on the exchange (at 98) and accumulate additional weather credits in order to be entitled to compensation. Compensation is only be paid when the party seeking compensation has sufficient weather credits, i.e., has paid a sufficient amount of premium.

If there are sufficient weather credits to entitle compensation (at 100), then the party seeking compensation is paid compensation (at 102) and the number of weather credits in the compensated party's account is reduced by a number corresponding to the compensation paid (at 104). That party can then proceed to conduct additional transactions on the exchange (at 98).

The principles of the present invention could also be applied to purchasers of a commodity not purchased through an electronic commerce exchange, but purchased, for example, from a wholesale or retail supplier, e.g., grass seed or any other commodity. In this case, a purchaser of a commodity would pay a premium for weather-related risk insurance when purchasing the commodity, e.g., the premium could be optionally added to the cost or it could be included in the price of the commodity and not overtly disclosed to the purchaser. The premium could be dependent on the weight (or volume amount, etc.) of the commodity sold, the selling price, or any combination thereof. The more of the commodity purchased by the consumer, the more premium paid and thus the more weather credits and insurance coverage obtained. Weather credits for subsequent purchases may be accumulated, as described in the examples hereinafter. Upon the occurrence of a weather-related incident, the consumer would be entitled to compensation based on the amount of premium paid (as reflected by the number of weather credits accumulated). As described above, a threshold amount of weather-related risk premium must be paid or a threshold amount of weather credits must be accumulated in order to be entitled to compensation. As such, each purchase and related premium payment is tracked and totaled in respective, separate accounts. In this example, the accounts may be kept at the supplier of the commodity, or at a central location to which the supplier is electronically connected, i.e., via the Internet.

While particular embodiments of the invention have been shown and described, it will be obvious to those skilled in the art that changes and modifications may be made without departing from the invention in its broader aspects, and therefore, the aim in the appended claims is to cover all such changes and modifications as fall within the true spirit and scope of the invention.

What is claimed is:

1. A method for bundling a weather-related insurance product in conjunction with trading a commodity through an electronic exchange, comprising:
creating a weather-related insurance product for the commodity, the insurance product providing a predetermined coverage, requiring payment of premium and providing for compensation for a weather-related incident;
posting offers by counter-parties to buy and/or sell the commodity on the exchange;
receiving an acceptance from a counter-party indicating an intention to create an agreement to trade the commodity;
when an acceptance is received, notifying the counter-parties (buyer and seller) that an agreement to trade the commodity has been accepted; and
including the insurance product in the agreement such that weather-related insurance is integrated into the trading transaction, subject to the terms and conditions set forth in the insurance product.

2. The method of claim 1, wherein including the insurance product in the agreement comprises requesting acceptance of the insurance product by at least one of the counter-parties, and then including the insurance product in the agreement for the at least one accepting counter-party.

3. The method of claim 1, wherein the insurance product is automatically included in the agreement for both counter-parties when the transaction is made.

4. The method of claim 1, further comprising enabling each counter-party to commit to automatically accept the insurance product for all subsequent agreements involving the counter-party within a specified period of time.

5. The method of claim 1, further comprising defining the terms and conditions of the insurance product to allot weather credits to counter-parties upon payment of the premium, wherein each weather credit corresponds to an amount of paid premium.

6. The method of claim 5, further comprising defining the terms and conditions of the insurance product to specify the number of weather credits required to obtain compensation pursuant to the insurance product.

7. The method of claim 5, further comprising accumulating the weather credits for the counter-parties in respective, separate accounts.

8. The method of claim 7, further comprising defining the terms and conditions of the insurance product to compensate a counter-party for a weather-related incident after a predetermined number of weather credits have been accumulated and to reduce the number of weather credits in the respective account by a number of weather credits corresponding to the dollar value of the claim paid.

9. The method of claim 5, further comprising defining the terms and conditions of the insurance product to set a limit on the number of weather credits that can be used for each weather-related incident.

10. The method of claim 1, further comprising defining the terms and conditions of the insurance product to enable compensation for a claim irrespective of a direct loss.

11. The method of claim 1, further comprising defining the terms and conditions of the insurance product to require a direct loss in order to obtain compensation.

12. The method of claim 1, further comprising defining the terms and conditions of the insurance product to specify events that qualify as a weather-related incident.

13. The method of claim 1, further comprising defining the terms and conditions of the insurance product to specify the amount of compensation to be paid for a weather-related incident based on a multiple of the premium paid.

14. The method of claim 1, wherein creating the insurance product comprises analyzing a weather-related risk for the commodity and determining the premium based on the associated weather-related risks accepted.

15. The method of claim 14, wherein the weather-related risk is analyzed based on the geographical area in which the risk exists.

16. The method of claim 14, wherein the weather-related risk is temperature above or below a threshold temperature.

17. The method of claim 14, wherein the weather-related risk is rainfall at least one of above a threshold or below a threshold.

18. The method of claim 14, wherein the weather-related risk for the commodity is analyzed and the premium for the commodity is determined prior to the acceptance or confirmation of a trade transaction.

19. The method of claim 1, further comprising assigning a standard unit of exchange for the commodity, the premium being determined per standard unit of exchange for the commodity.

20. The method of claim 1, further comprising connecting the counter-parties to a server over a communication network, the counter-parties being notified of the offers to buy and sell by transmitting the offers to buy and sell from the server over the communication network, the acceptances from the counter-parties being received at the server over the communication network; and when acceptances are received by the server, the counter-parties being notified that agreements to trade the commodity have been created via the communication network.

21. A method for bundling a weather-related insurance product in conjunction with trading a commodity through an electronic commerce exchange, comprising:
creating a weather-related insurance product for the commodity, the product providing for a predetermined coverage, requiring payment of premium and providing compensation for a weather-related incident;
forming trade agreements between counter-parties (buyer and seller) of the commodity on the exchange using a server and remote terminals connected over a communication network to the server; and
including the weather-related insurance product in the trade agreements and thereby providing the coverage to the buyers and sellers.

22. The method of claim 21, further comprising defining the terms and conditions of the insurance product to allot weather credits to the counter-parties upon payment of the premium, each weather credit corresponding to an amount of paid premium.

23. The method of claim 22, further comprising defining the terms and conditions of the insurance product to specify the number of weather credits required to obtain compensation pursuant to the insurance product.

24. The method of claim 22, further comprising accumulating the weather credits of each counter-party in respective, separate accounts.

25. The method of claim 24, further comprising defining the terms and conditions of the insurance product to enable compensation to a counter-party for a weather-related incident after a predetermined number of weather credits have been accumulated by the counter-party and to reduce the number of weather credits in the payee's account by a number of weather credits corresponding to the compensation paid for the incident.

26. The method of claim 21, further comprising defining the terms and conditions of the insurance product to enable compensation for a claim irrespective of a direct loss.

27. The method of claim 21, further comprising defining the terms and conditions of the insurance product to require a loss to obtain compensation.

28. The method of claim 21, further comprising defining the terms and conditions of the insurance product to specify events that qualify as a weather-related incident.

29. The method of claim 21, further comprising defining the terms and conditions of the insurance product to specify the compensation to be paid for a weather-related incident based on premium paid.

30. The method of claim 21, further comprising assigning a standard unit of exchange for the commodity, the premium being determined per standard unit of exchange for the commodity.

31. The method of claim 21, further comprising arranging for the payment of the premium over the communication network.

32. The method of claim 21, wherein the step of including the insurance product in the agreement comprises requesting acceptance of the insurance product by at least one of the counter-parties, and then including the insurance product in the agreement for the at least one accepting counter-party.

33. The method of claim 21, wherein the insurance product is automatically included in the agreement for both counter-parties when the transaction is made.

34. The method of claim 21, further comprising enabling each counter-party to commit to automatically accept the insurance product for all subsequent agreements involving the counter-party within a specified period of time.

35. A method for bundling a weather-related insurance product in conjunction with sale of a commodity, comprising:
creating a weather-related insurance product for the commodity, the insurance product providing for a predetermined coverage, requiring payment of premium and providing for compensation for a weather-related incident;
including the premium in the price of the commodity; and
selling the commodity;
whereby a buyer of the commodity is entitled to compensation for a weather-related incident pursuant to the product.

36. The method of claim 34, further comprising determining the compensation for each buyer based on the amount of commodity bought by the buyer.

37. The method of claim 36, wherein determining the compensation for each buyer comprises summing the amount of the commodity bought by the buyer to determine the amount of premium paid by the buyer, and determining the compensation to the buyer based on the premium paid.

38. The method of claim 37, further comprising enabling compensation to each buyer seller only after the amount of premium paid by the buyer is equal to or exceeds a minimum amount of premium.

39. The method of claim 34, further comprising conditioning compensation to each buyer on the purchase of a minimum amount of the commodity.

40. The method of claim 34, further comprising defining the terms and conditions of the insurance product to allot weather credits to each buyer, each weather credit corresponding to an amount of paid premium.

41. The method of claim 40, further comprising defining the terms and conditions of the insurance product to specify the number of weather credits required to obtain compensation pursuant to the insurance product.

42. The method of claim 40, further comprising accumulating the weather credits of each buyer in respective, separate accounts upon the buyer making multiple purchases of the commodity.

43. The method of claim 42, further comprising defining the terms and conditions of the insurance product to enable compensation to each buyer for a weather-related incident after a predetermined number of weather credits have been accumulated by the buyer and reduce the number of weather credits in the compensated buyer's account by a number of weather credits corresponding to the compensation paid for the incident.

44. A system for trading a commodity through an electronic commerce exchange, comprising:
a server for insuring trades of the commodity on an electronic commerce exchange, said server comprising a processor and a memory component including a trading program;
links for coupling said server to remote terminals accessible by buyers and sellers of the commodity over a communication network; and
a risk assessment program for creating an insurance product based on weather-related risk of the trades on the electronic commerce exchange, the insurance product providing for a predetermined coverage and including a premium, covered incidents and compensation payable for the covered incidents, said risk assessment program being coupled to said processor such that said processor notifies the trade participants of the terms and conditions of the insurance product, the insurance product being issued upon payment of the premium.

45. The system of claim 44, wherein said risk assessment program is resident on said memory component.

46. The system of claim 44, wherein said risk assessment program is resident on a server of an insurance company, said insurance company server being coupled to said trade-insuring server over the communication network.

47. The system of claim 44, wherein said processor is arranged to total the amount of premium paid in conjunction with trades by the buyers and sellers in respective, separate accounts and upon occurrence of a covered incident, authorize compensation only when the amount of premium paid is equal to or greater than a threshold amount of premium.

48. The system of claim 44, wherein said processor is arranged to assign weather credits to the buyers and sellers as a function of the premium paid in conjunction with trades by the buyers and sellers, accumulate the weather credits in respective, separate accounts for the buyers and sellers, and upon occurrence of a covered incident, authorize compensation only when the accumulated total of weather credits is equal to or greater than a threshold amount of weather credits.
